(19) United States
(12) Patent Application Publication
(10) Pub. No.: US 2010/0193424 A1
(43) Pub. Date: Aug. 5, 2010

(54) CAPILLARY MEMBRANE FILTER WITH MANUALLY ACTIVATED BACKWASH PUMP

(76) Inventors: Johan Jan Scharstuhl, Lommel (BE); Thomas Weis, Epalinges (CH)

Correspondence Address: JAMES C. WRAY, 1493 CHAIN BRIDGE ROAD, SUITE 300, MCLEAN, VA, 22101, US

(21) Appl. No.: 12/733,080

(22) PCT Filed: Aug. 8, 2008
(86) PCT No.: PCT/IB2008/002094

§ 371 Date: Mar. 30, 2010

(30) Foreign Application Priority Data
Aug. 8, 2007 (NL) 2000799

(51) Int. Cl. B01D 65/02; B01D 63/04; B01D 61/18

(52) U.S. Cl. 210/321.61; 210/321.69

(57) ABSTRACT

Apparatus for filtration of contaminated water, characterised in that the apparatus is provided with a housing (1) which, when oriented for proper use, comprises—a contaminated water inlet (2) and a drain (8, 13),—a water filter in the housing, the filter comprising capillary membranes (3) embedded in a sealant at their upper and lower side such that they are completely sealed against the housing, —a permeate connector (5) for the drainage of the permeate, —a backwash connector (6) for the backwashing of the membrane at the housing, —a manually activated pump (9, 10) connected to the back-wash connector, wherein the backwash connector (6) is located under the permeate connector (5).

### FIELD OF THE INVENTION

The present invention relates to a device for filtration of contaminated water, especially for household application.

### BACKGROUND OF THE INVENTION

Millions of people in the world only have access to seriously contaminated water, especially contaminated with bacteria and virus. For this reason, different kinds of water filtering devices are proposed as point of use devices or as household devices.

U.S. Pat. No. 4,636,307 by Inoue et al. and European patent application EP 617 951 disclose portable water purification units with a prefilter of activated carbon or ion exchange resin in series with a hollow fibre module.

If no pre-filter is used, a hollow fibre module has a tendency to clog due to the accumulation of contaminants upstream of the fibres. Clogging of hollow fibre filters is generally known in prior art filters, for example as disclosed in U.S. Pat. No. 7,179,636 by Guillot et al, where backwash is used by a peristaltic pump in order to clean the hollow fibres. A peristaltic pump, however is not a practicable solution for a portable point-of-use device. Therefore, it would be advantageous to find a different solution.

A portable water cleaning device, a photo of which is reproduced in FIG. 8, is commercially available by the company Milleniumpore®. In this device, a water tank 102 is connected via a hose 104 to the lower part of a filtering unit 106. By manually activating a balloon 108, air is pumped into the tank creating pressure driving water from the tank 102 into the filtering unit 106 and after the filtering action out of the filtering unit 6 through a second hose 110 at the upper part 112 of the filtering unit 106. This second hose 110 is connected to a clean-water tank 114 in which water is accumulated for discharge through third hose 116 if the water level in clean-water tank is above the height of the connection 118 with the third hose 116. When the filter in the filtering unit 106 is clogging, the clean water from the clean-water tank 106 can via hose 110 be pressed backwards into the filtering unit 106 by activation of balloon 120 creating pressure in clean-water tank 114.

Though fulfilling the need of providing clean water and having means for backwash of the filter, this device is bulky and not so attractive for nomads in rural areas, where the easy transportation of the filter from one place to another is important. Ease of transportation is also necessary in the case that the filtering unit is used for refugees that have to move quickly from one place to another. In practice, this Milleniumpore® water cleaning device has to be emptied for transportation due to weight reduction. However, when being started up again, enough water has to be pumped through the filtering unit 106 in order to fill clean water tank 114, because water can only be released from the device, when clean water tank is filled up with clean water. These features makes this device unsuitable as a portable water filter.

Another disadvantage of the Milleniumpore filter is the fact that the filter needs manual pressure by the balloon in order to drive the water through the filtering unit. It would be desirable to have an easier method for filtering.

### OBJECT OF THE INVENTION

Therefore, it is the object of the invention to provide a small hollow-fibre point-of-use or household filtering unit that is easy to use and transport.

### DESCRIPTION OF THE INVENTION

This object is achieved with an apparatus for filtration of contaminated water, characterised in that the apparatus is provided with a housing which, when oriented for proper use, comprises
a contaminated water inlet upstream of a water filter
a water filter with capillary membranes embedded in a sealant at their upper and lower side such that they are completely sealed against the housing,
a permeate connector downstream of the water filter for the drainage of the permeate,
a backwash connector at the housing located downstream of the water filter and underneath the permeate connector for the backwashing of the membrane
a drain at the lower end of the housing,
a manually activated pump connected to the backwash connector.

In contrast to the Milleniumpore filtering device as described above, the backwash connector of the housing is located under the permeate connector of the housing. The advantage is easily understood from the following. If the backwash connector, which preferably is a short spout of the same kind as the permeate connector, is located above the permeate connector, air may be trapped in the manual backwash pump such that proper backflush is not possible due to the air-blocking hydrophilicity of the capillaries, unless there is used an intermediate clean water tank as in the case of the Milleniumpore® device, where the air pressure from the balloon presses an the water in the clean water tank for backwash. However, by providing the manual pump under the permeate connector, the pump volume, for example from the balloon, will be filled with water together with the filter, before water is extracted through the permeate connector. Thus, it is always guaranteed that the backwash facility by the manual pump, for example the balloon, is functioning if there is water in the water filter. By these means, there is no need for a separate clean water tank in addition to the filtering housing, because the manual pump for backwash is directly connected to the housing and filled with water during standard use.

Preferably, the manually activated pump may be a piston pump, but preferred is a squeeze pump, such as a flexible bellow/balloon, but other squeeze pump may be applied as well.

In certain embodiments, the permeate connector is at the side of the housing, however, this is not strictly necessary. Also, for the water inlet, there is no strict location requirement. However, a certain configuration is advantageous, where the water inlet is at the bottom of the housing, because water supply to the housing will press air out of the filter, if the housing is provided with an upper drain valve.

In certain embodiments, the manual pump is connected directly to the backwash connector. This is a very compact solution, especially if the pump is a balloon. The compactness is achieved to a great degree, if the housing is a tubular housing with relatively small dimensions, for example with cross sectional dimensions having a circumscribed circle with a diameter of 50 mm at most. Preferably, the housing is cylindrical with a diameter of at most 50 mm.

Alternatively, the pump, preferably a balloon, is connected to the backwash connector via a hose, the hose having a first end connected directly to the pump and a second end connected directly to the backwash connector. Thus, no intermediate water tank is necessary as in the Milleniumpore case. Only a relatively small volume of water is necessary for having a backwash facility guaranteed, which also is in contrast to the Milleniumpore device, where a relatively large clean water tank must be filled and kept filled for having a functioning backwashable filter. In the case of transportation, a compact filter according to the invention is easier to accept if filled with water than the Milleniumpore device, because the amount of water for the filter can be made much smaller as there is no necessity for an intermediate tank.

If a manual pump, for example a balloon, is connected to the filter via a flexible hose, typically, the pump would hang down relatively to the backwash connector and would be filled with water.

In a further embodiment, the housing comprises a reservoir (7) for the accumulation of the contaminants in the lower part of the housing. These contaminants are allowed to accumulate over time, until the lower drain is opened for discarding the contaminants.

Use of the apparatus for gravity feeding is a preferred option. For this reason, in a further embodiment, the apparatus comprises a feed water reservoir with contaminated water located at least 50 cm, rather at least 1 meter, above the housing for gravity feeding of the water to the housing.

As the filter with hollow fibres is an efficient water cleaner, and a proper functioning of the backwash facility is guaranteed during proper use, even after transportation under dry conditions, there is no strict need for any chemical pre-filtering step in most cases. Therefore, in a further embodiment, the apparatus is free from any chemical pre-filtering step including an antimicrobial source, activated carbon and ion exchange resin. Possibly, only a physical coarse filter is used to avoid relatively large particles to enter the capillary filter.

Advantageously, the capillary membrane filter unit is configured for stopping virus, bacteria and parasites with a size of more than 0.2 microns. For example, hydrophilic membranes are used with an inner microbe separation layer having a pore size of between 0.1 and 0.2 microns. If using a tubular housing with a cross section having a circumscribed circle with diameter of less than 50 mm and a length of the housing of less than 40 cm, a flow of at least 1 litre in 10 minutes can be achieved, which is sufficient for most applications as household filter in rural areas. By being able to use the filter under gravity conditions with a contaminated water tank located a distance above the housing, water will gradually flow through the housing and be filtered. No intervening action, for example squeeze pump action, is necessary, which is highly convenient for the user.

For example, the capillary membranes have a flux of 1000-1500 L/m²/hr/bar, for example 1200-1500 L/m²/hr/bar. In other words, for each square meter surface area of the membranes, the throughput is 1000-1500 L per hour or 1000-1500 L per hour, respectively, if the pressure is one bar. At a gravity height of 1 meter, the pressure is 0.1 bar. If 1 m² of membrane surface is located in the housing, the water flow is theoretically between 100 and 150 litre per hour or 120 and 150 litre per hour.

Preferably, the surface of the capillary membranes is inert in order not to bind positively or negatively charged particles at the surface. The inertness counteracts clogging in the filter.

The sealing of the capillary membranes against the housing is preferably made by epoxy resin or by polyurethane.

An advantageous material for the capillary membranes is a composition comprising PolyEtherSulfone (PES), PolyVinylPyrrolidone (PVP) and zirconium oxide (ZrO₂), for example as described in European patent EP 241 995.

Some selected embodiments may involve the following:
the housing is elongate with a longitudinal axis, and the manually activated pump comprises a bellow with first shoulders and second shoulders for compression of the bellow when the first shoulders are pressed towards the second shoulders along a longitudinal axial direction of the housing; or
the housing is elongate with a longitudinal axis, and the manually activated pump comprises a set of handles for compressing a bellow, the handles being hinged for compression movement of the bellow in a direction substantially normal to the longitudinal axis of the housing; or
the manually activated pump comprises a single handle for compressing a bellow, the handle being hinged for compression movement of the bellow in a direction substantially normal to the longitudinal axis of the housing, wherein the handle also comprises a squeezer for closing a drain tube when the bellow is not compressed, or
the manually activated pump comprises a compressible balloon covering part of a surface of the housing.

Optionally, for backwash operation, the housing may contain a floating ball for closing the water inlet, when the water level rises in the housing with increased pressure from the manual pump.

### DESCRIPTION OF THE DRAWING

The invention will be explained in more detail with reference to the drawing, where

FIG. 1 illustrates the principle of an apparatus according to the invention for the filtering of contaminated water,

FIG. 2 is a schematic drawing of an apparatus before filling a backwash piston with clean water,

FIG. 3 is a schematic drawing of an apparatus according to FIG. 2 after filling a backwash piston with clean water,

FIG. 4 is a schematic drawing of an apparatus according to FIGS. 2 and 3 after backwash with the piston,

FIG. 5 is a schematic drawing of an apparatus with a filled backwash balloon,

FIG. 6 is a schematic drawing of an apparatus after backwash with the balloon,

FIG. 7 is a different embodiment with a balloon connected to the backwash connector, where a) the water inlet is at the upper side and b) the water inlet is at the lower side,

FIG. 8 is a prior art filtering device from the company Milleniumpore®;

FIG. 9 is a further embodiment, where the hand pump is a balloon in the form of a squeezing bellow operated axially to the filter, the left part of the drawing shows the apparatus before squeezing and the right part after squeezing;

FIG. 10 illustrates an embodiment with a bellow having radially operated handles, the left part of the drawing shows the apparatus before squeezing and the right part after squeezing;

FIG. 11 illustrates an embodiment with a bellow operated with a handle at the side of the housing, the left part of the drawing shows the apparatus before squeezing and the right part after squeezing;

FIG. 12 illustrates an embodiment with a balloon/bellow attached to the side of the housing.

### DETAILED DESCRIPTION OF THE INVENTION

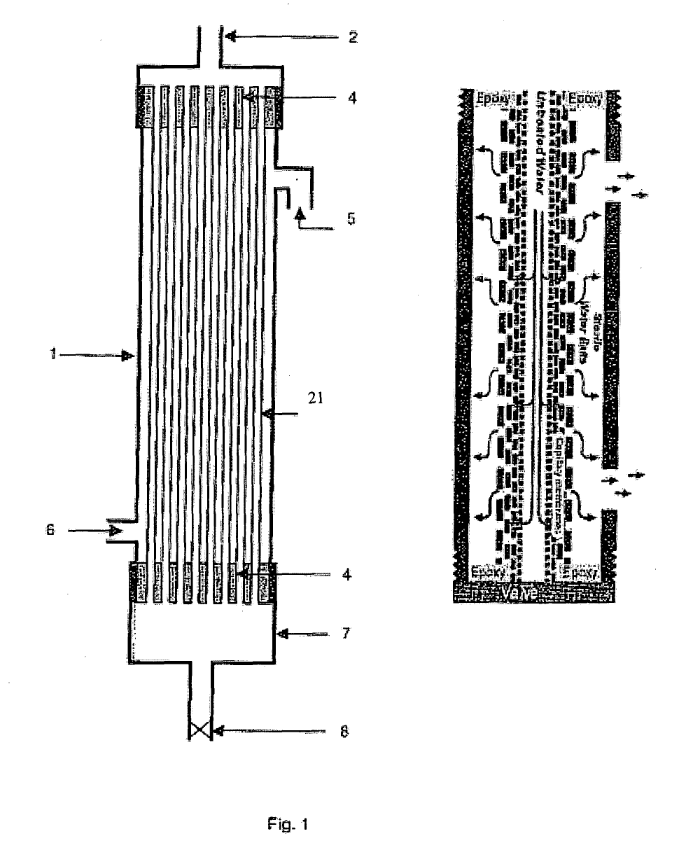

FIG. 1 illustrates an apparatus for filtration of contaminates water. The capillary membranes 3 are embedded in an epoxy resin or polyurethane, whereby the space 4 between the capillary membranes 3 and the housing 1 is sealed. During manufacture, the capillaries were potted in the resin and cut off at the ends, typically 5 mm from the potting end. The tubular, preferably cylindrical, housing is provided with a permeate opening 21 in the form of a permeate connector for the drain of the permeate from the filter into a clean water reservoir 11. Below the permeate connector 21, a backwash opening 6 in the form of a backwash connector is provided at the housing for backwashing of the membrane to counteract clogging of the membranes. The upper end of the housing is provided with a contaminated water inlet and the lower end is provided with a reservoir 7 for accumulation of contaminants from the contaminated water. The housing 1 has a drain valve 8 beneath the reservoir for drain of the contaminants from the reservoir 7.

For use, water is provided from a raw water reservoir (not shown) through water inlet 2 into the filter housing in order to fill the housing with water. For filling with water after having been emptied, the drain valve is opened for escape of air, which results in the filling of the housing within a few seconds. Alternatively, the air may escape through the water inlet. In order to get air trapped in the filter to leave the filter most quickly, the housing 1 may be turned upside down such that the water flows into the housing through the water inlet 2 from beneath and the air escapes through opened drain valve 8 above. For proper filtering, the housing 1 is brought back to the original correct orientation. For the filtration, the water flows through the capillary wall from the inner space of the capillary and through permeate connector 21. The filtrate from the contaminated water is accumulated in the reservoir 7 at the bottom of the housing.

The apparatus is especially suited as a portable water filter or a household filter. Particularly, the apparatus contains ultrafiltration capillary membranes.

After a certain time of use, the pores of the capillary membrane may be subject to clogging such that the filtration time and speed is unacceptable long. To restore the filtering capabilities, the membranes 3 are backwashed.

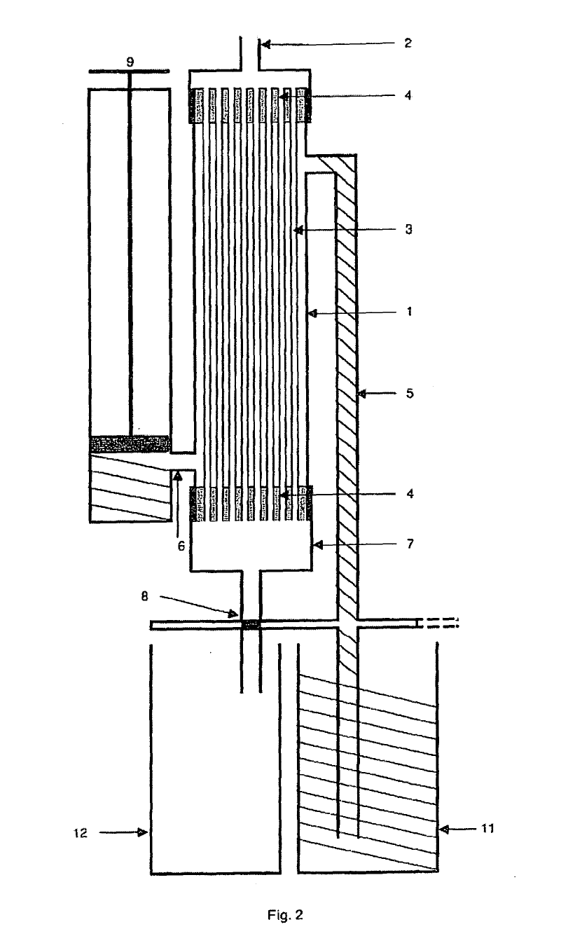

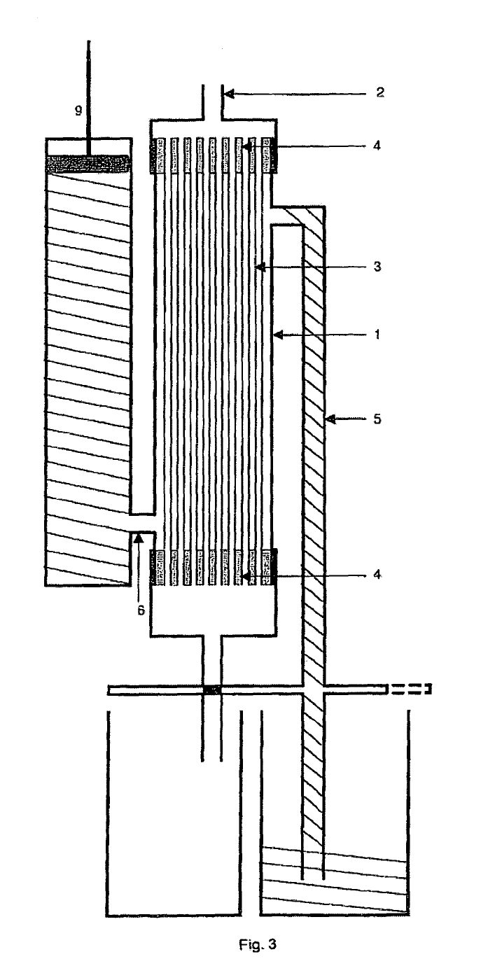

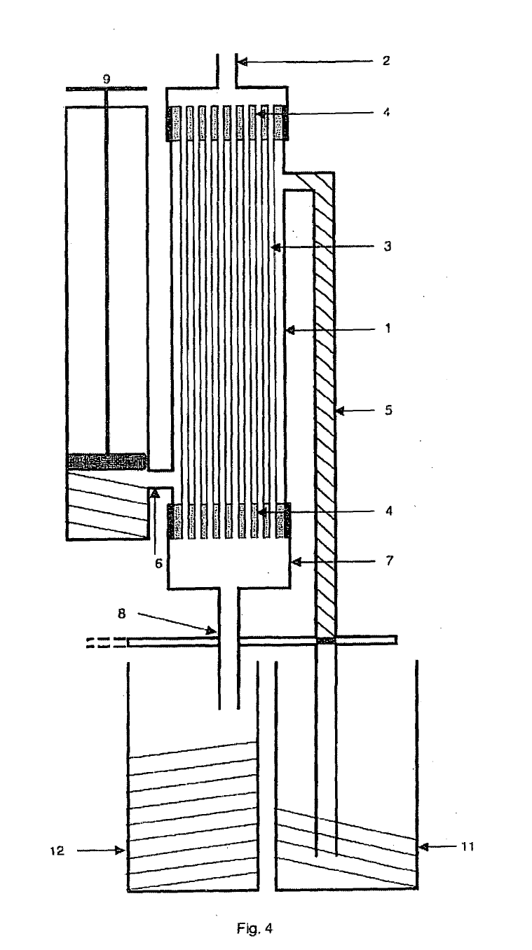

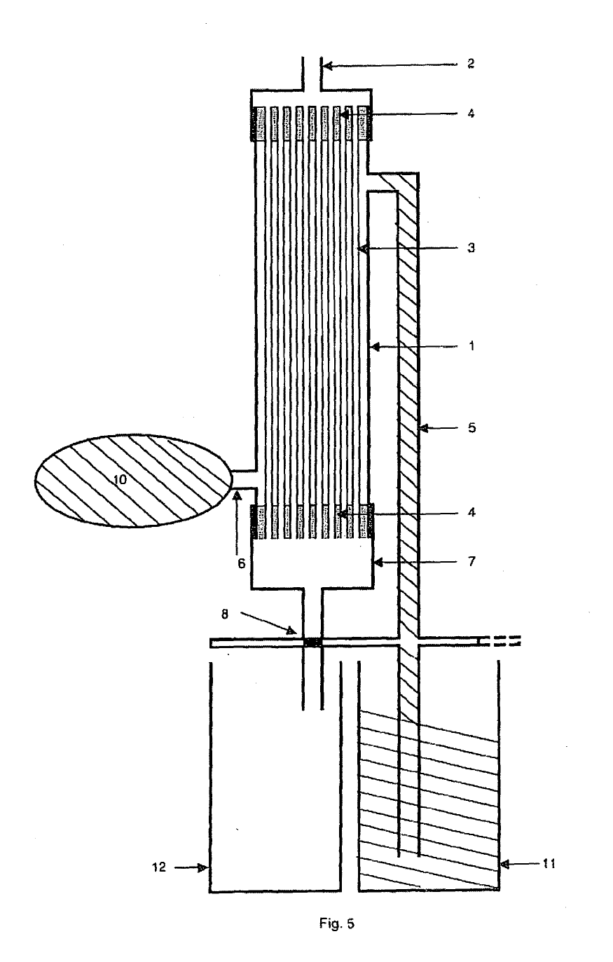

A first backwash principle is illustrated in a sequence of FIGS. 2, 3, and 4. In FIG. 2, a manually operated piston pump for backwash is shown in the position, where the piston is just above the backwash connector 6 such that the volume beneath the piston is filled with clean water. In FIG. 3, the piston 9 has been pulled up by sucking clean water from the clean water reservoir 11 through the space between the capillaries. Possibly, also water has been pulled through the capillaries from the contaminated water inlet such that the water below the piston 9 is clean water. The permeate connector 21 with a permeate tube 5 may then be closed and the drain valve 8 opened, such that pressure exerted on the flush water from the manually pressing down of the piston 9 forces the water backwards through the membranes 3 and out of the drain valve 8 into drain reservoir 12, the flush water loosening contamination from the inner surface of the membranes 3 and removing those together with the flush water as illustrated in FIG. 4.

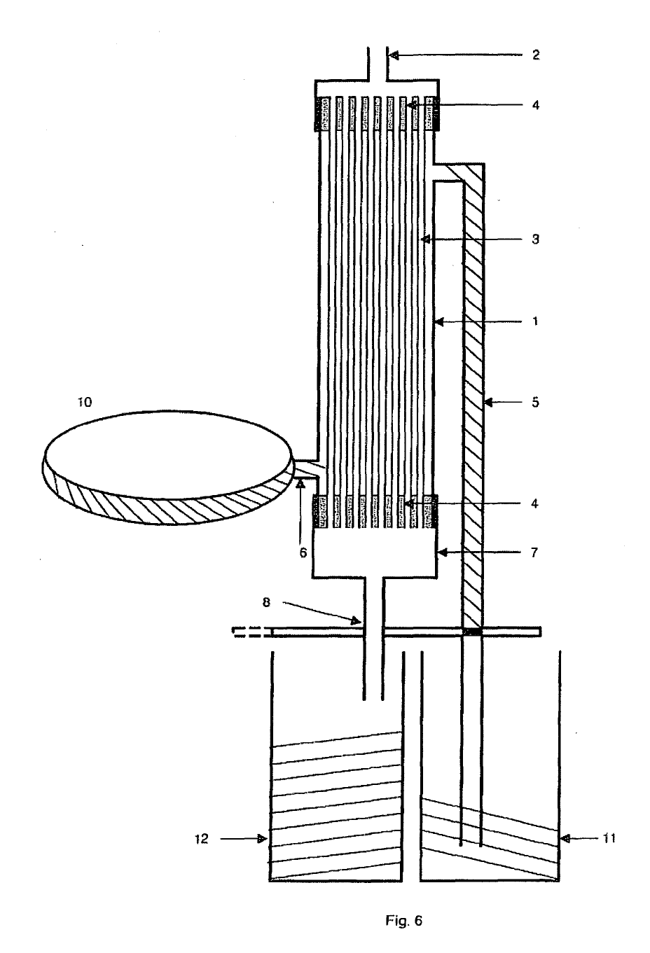

FIGS. 5 and 6 illustrate an alternative embodiment, where the piston is substituted by a squeeze pump in the form of a flexible manually operated balloon 10. The balloon 10 connected to backwash connector 6 and being located below the exit for the permeate connector 21 is filled with clean water. By closing permeate connector 21 with the permeate tube 5, opening the drain valve 8, and pressing the balloon 10 together, as illustrated in FIG. 6, the water from the balloon backwashes the capillaries through the drain valve 8 into the drain reservoir 12. Closing the valve 8 and opening for the permeate connector 5 will cause the balloon to suck water into the inner volume of the balloon from the clean water reservoir 11. Alternatively, the balloon 10 is filled with filtered water from the contaminated water inlet 2 through the capillary filter 3.

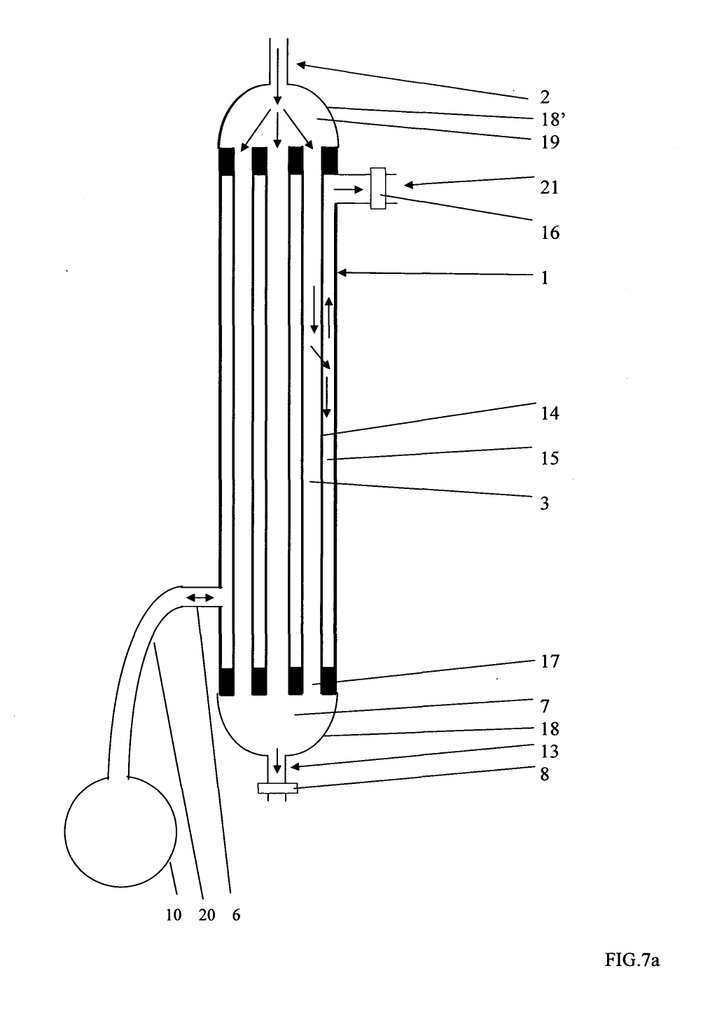

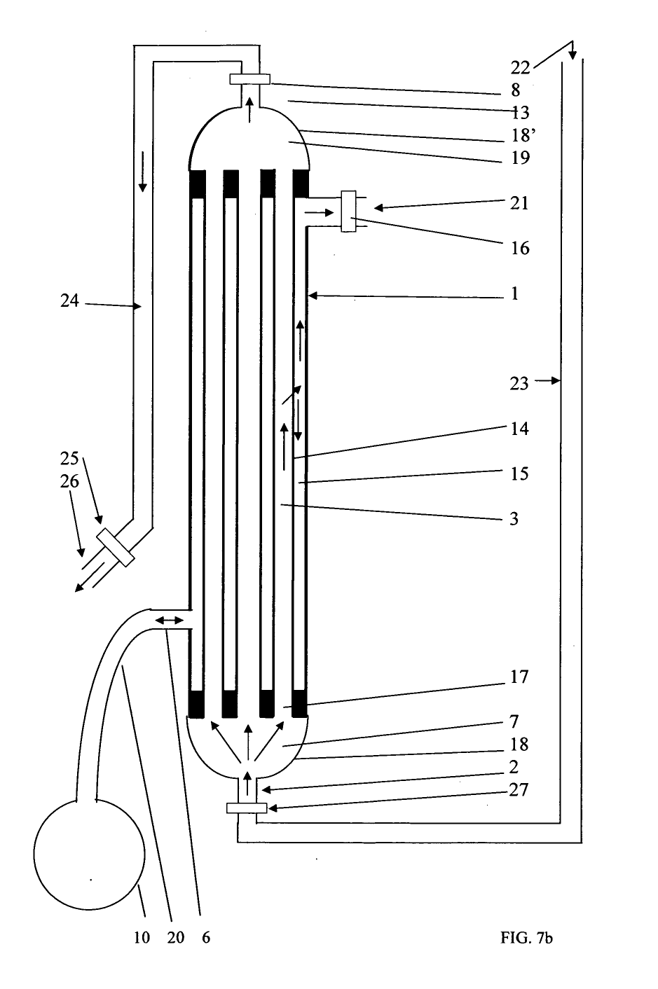

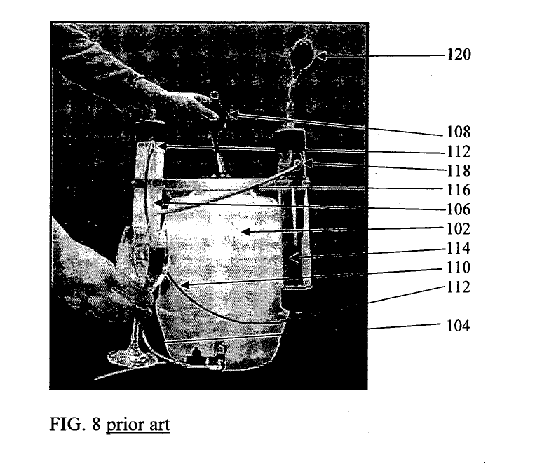

When the balloon of FIGS. 5 and 6 is operated, the backwash connector 6 is typically subject to a certain force which implies a risk for breaking the connector 6, especially if the housing 1 is made of a light weight polymer. An improvement with reduced risk for breakage is shown in FIG. 7 illustrating a further embodiment, where a bellow in the form of a balloon 10 is connected to the backwash connector 6 by a hose 20 which reduced the load on the connector 6 when the balloon 10 is manually squeezed. With respect to the load, the hose 20 decouples the balloon 10 from the backwash connector 6.

The apparatus 1 of FIG. 7a, also in this case, comprises a number of microporous capillaries 3 into which water or other fluid enters through a water inlet 2. The water flows through the capillaries 3 into drain reservoir 7 in the lower end, from which it can be released through a valve 8 at the drain water outlet 13 in the case of forward flush, where water flows directly from the water inlet 2 through the housing along the inner capillary walls and through drain valve 8. If the drain valve 8 at the second outlet 13 is closed, the pressure on the water drives the water through the capillary walls 14 and into the interspaces 15 between the capillaries 3. From the interspaces 15, the water can be released for consumption through permeate connector 5 having a valve 16 as well.

The balloon 10 is made of a compressable material, for example a flexible polymer that can be manually compressed. When the permeate outlet 5 is closed by the valve 16, and pressure is exerted on the balloon 10, pressure drives the water from the balloon through the capillary walls 14 and back into the capillaries 3. This backwash presses microbes and other particles out of the capillary pores and away from the inner surface of the capillaries 3. The cleaning can be further supported by a subsequent or simultaneous forward flush through drain valve 8 removing the microbes and particles from the filtration apparatus 1.

In order to provide a proper flow through the housing 1, the lower reservoir 7 between the open outlet ends 17 of the capillaries 3 and the drain valve 8 is formed with bending walls 18, for example walls with a semispherical shape. The advantage of such shape is a proper flow without substantial turbulence also for those capillaries that are located close to the housing 1. This is in contrast to a flat end cap, which in certain configurations restricts the flow through the outermost capillaries such that an uneven flow is provided, which is disadvantageous, especially, in forward flush situations. Likewise, an inlet chamber 19 is provided with a bending chamber wall 18′, in order to provide a proper flow into the outermost capillaries.

In FIG. 7b, an apparatus is shown very much like the apparatus of FIG. 7a, however, differing in having the fluid inlet 2 at the lower side instead of at the upper side. Instead, the water outlet 13 and the drain valve 8 are located at the upper end of the housing instead at the lower end. Thus, when the housing is correctly oriented for proper use, the water enters 22 connection tube 23 from a water reservoir, for example positioned half a meter or one meter or more above the filter hosing 1 in order to utilise the gravity pressure to drive the water through the filter capillaries 3. The water from the water reservoir flows through tube 23 and through water inlet 2 into the filter housing 1. The filtered water leaves the housing through permeate connector 21. In case of flush, the water inlet 2 is, optionally, closed by an inlet valve 27. The closing is convenient, but not absolute necessary. In fact, if the filter is subject to backflush and forward flushing at the same time, the inlet valve 27 is kept open. In case of the backflush or forward flush situation, the drain valve 8 is opened and the drain water leaves the housing through drain tube 24 and out of drain tube exit 26. Optionally, there is provided a drain tube valve 25 in addition to drain valve 8 or as an alternative. Also in this configuration, the permeate connector 21 is positioned above the backwash connector 6 during proper filtering. However, for backwash, the orientation of the housing may be changed such that the drain valve 8 is oriented downwards.

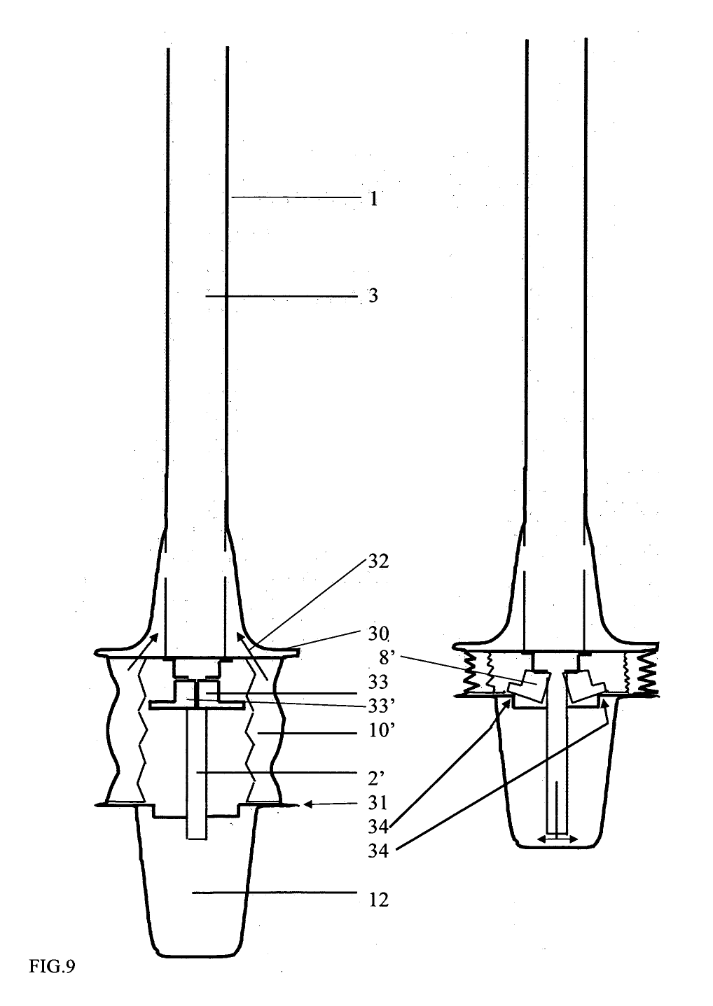

FIG. 9 illustrates an alternative embodiment. Also, in this case, the housing 1 contains a capillary filter 3, a drain 2′, and a drain valve 8. In extension of the lower part of the housing 1, a compressible bellow 10′ is provided. The bellow 10′ has first shoulders 30 and second shoulders 31 for compression of be bellow 10′ when the first shoulders 30 are pressed towards the second shoulders 31 along the longitudinal axial direction of the cylindrical housing 1, which is illustrated in the right drawing of FIG. 9. When this compressible bellow is axially compressed, the water in the bellow is forced into the housing, which is illustrated by arrows 32 and which causes backwash of the filter. The second shoulders 31 of the compressed bellow 10′ open a valve 8′ by pressing against two rotating squeezers 33, 33′ which are used to squeeze flexible drain tube 2′ between them. These squeezers 33, 33′ are activated by activation means 34 as part of the shoulders 31 for opening the drain valve 8′, when the bellow 10′ is compressed. Drained water flows then from the capillary filter 3 into a drain reservoir 12 attached to the lower part of the housing 1.

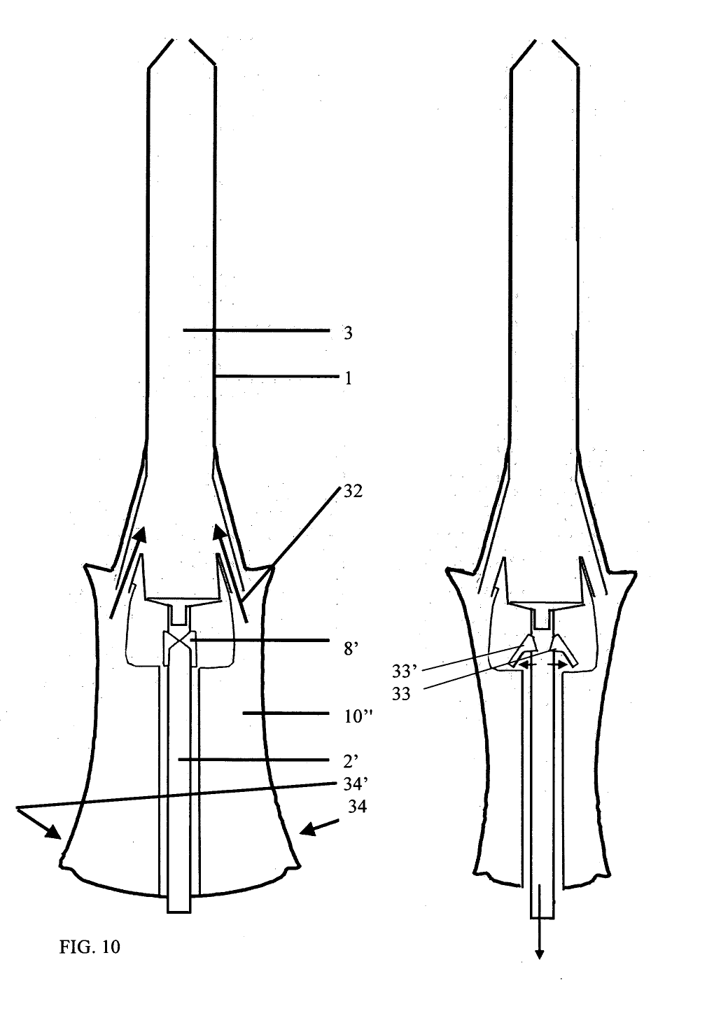

FIG. 10 illustrates an embodiment with a radially compressible bellow 10″. The bellow 10″ comprises a pair of handles 34, 34′, which, when pressed together, as illustrated in the right drawing of FIG. 10, forces water from the bellow 10″ into the filter 3, which is illustrated by arrows 32. The direction of the movement of the pairs of handles 34, 34′ is primarily in a direction radial to the cylindrical housing 1. Through drain valve 8′ and drain tube 2′, contaminated water is released, when the handles also activate the drain valve 8′, which comprises two rotational squeezers for squeezing the flexible drain tube 2 between them.

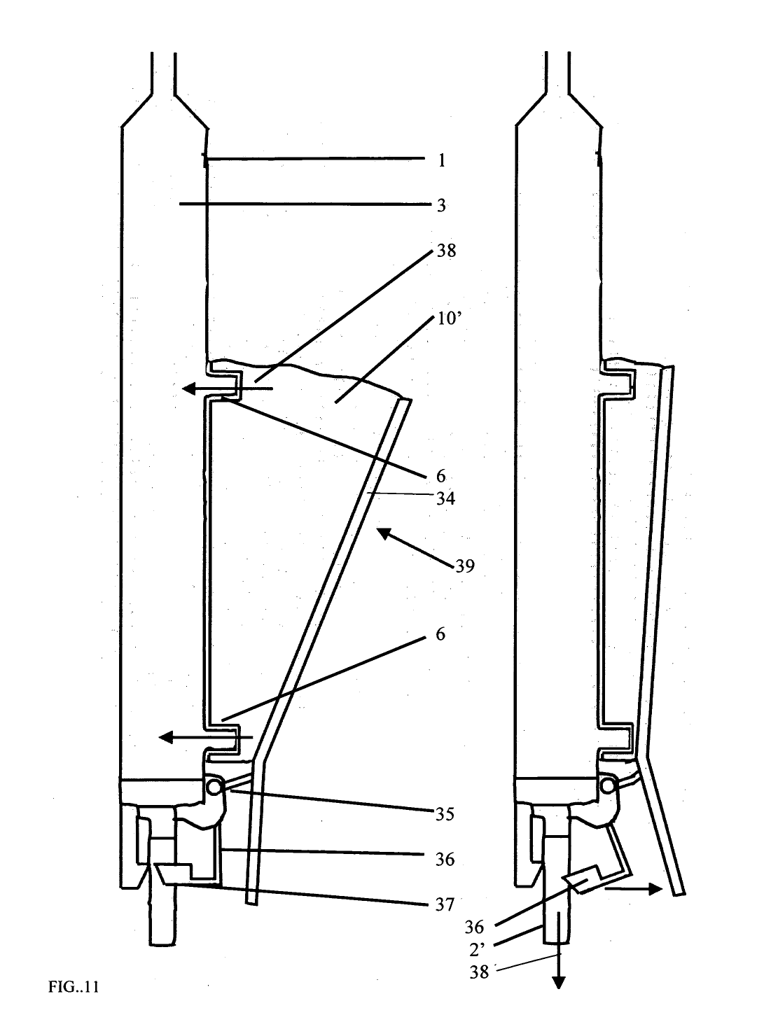

FIG. 11 illustrates an embodiment with a bellow 10′ operated by a handle 34 hinged rotationally to the housing 1 in a hinge 35. When the handle 34 is pressed towards the housing 1, which is illustrated by arrow 39, the bellow 10′ is compressed, forcing water from the bellow 10′ through the backwash connector 6 into the housing 1 for backwash of the filter 3. The handle 34 also operates a squeezer 37 as part of drain valve 8′ such that the drain tube 2′ is able to release—illustrated by arrow 38—the contaminated backwash water.

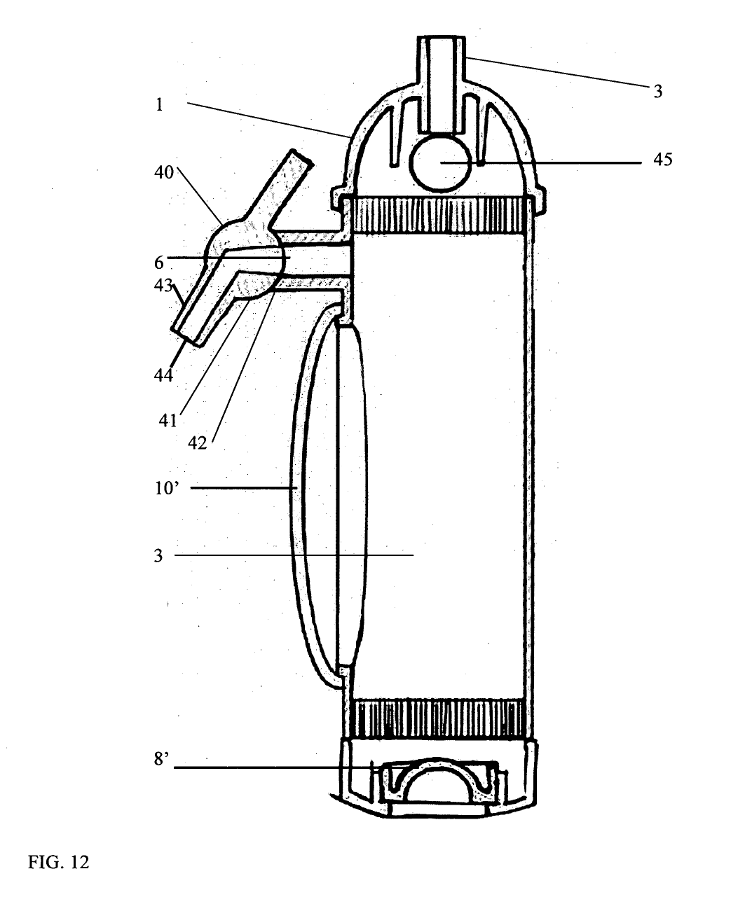

FIG. 12 illustrates an embodiment with a bellow/balloon 10′ attached to the side of the housing 1. By pressing the balloon, water is forced into the filter 3 and out of the drain valve 8′. The permeate outlet 6 is connected to a valve 40, which has a spherical part 41 in a corresponding spherical seat 42. By rotating the spherical part 41, the channel 44 of the spout 43 can be adjusted to cooperate or not cooperate with the permeate outlet 6, by which the valve 40 is open or closed. Optionally, for backwash operation, the housing may contain a floating ball 45 for closing the water inlet. Optionally, the drain valve 8′ is a pressure valve for automatic release of water when a certain water pressure is achieved with the balloon. For example, the pressure valve 8′ comprises a dome shaped arrangement of a plurality of adjacent lips in sealing contact with each other. When the pressure reaches a certain level, the lips are deformed sufficiently to open the valve for release of the backwash water.

1. Apparatus for filtration of contaminated water, wherein the apparatus is provided with a housing (1) which, when oriented for proper use, comprises
a contaminated water inlet (2) and a drain (8, 13),
a water filter in the housing, the filter comprising capillary membranes (3) embedded in a sealant at their upper and lower side such that they are completely sealed against the housing,
a permeate connector (5) for the drainage of the permeate,
a backwash connector (6) for the backwashing of the membrane at the housing,
a manually activated squeeze pump (9, 10) connected to the backwash connector (6),
wherein the backwash connector (6) is located under the permeate connector (5), and the squeeze pump (10) is directly connected to the backwash connector (6).

2. Apparatus according to claim 1, wherein the pump is a balloon (10).

3. An apparatus according to claim 1, the squeeze pump having a pump volume and is arranged to be filled with water together with the filter before water is extracted through the permeate connector.

4. An apparatus according to claim 1, wherein the apparatus is a portable point-of-use device.

5. An apparatus according to claim 1, wherein the housing is tubular with cross sectional dimensions having a circumscribed circle with a diameter of 50 mm at most.

6. An apparatus according to claim 1, wherein the apparatus is free from an intermediate tank (114) between the pump (10) and the backwash connector (6).

7. Apparatus according to claim 1, wherein the sealant is polyurethane.

8. Apparatus according to claim 1, wherein the sealant is epoxy resin.

9. Apparatus according to claim 1, wherein the capillaries membranes are hydrophilic.

10. Apparatus according to claim 1, wherein the capillary membranes are made of PES, PVP and ZrO₂.

11. Apparatus according to claim 1, wherein the capillary membranes have a flux of 1000-1500 L/m²/hr/bar.

12. Apparatus according to claim 1, wherein the capillary membranes are inert.

13. Apparatus according to claim 1, wherein the capillary membranes are ultrafiltration membranes with a pore size of between 0.01 and 0.1 microns.

14. Apparatus according to claim 1, wherein the capillary membranes are ultrafiltration membranes with a pore size of between 0.01 and 0.02 microns.

15. Apparatus according to claim 14, wherein the housing comprises a reservoir (7) for the accumulation of the contaminants.

16. An apparatus according to claim 1, wherein the apparatus is free from a chemical pre-filtering step.

17. Apparatus according to claim 16, wherein the apparatus is free from an antimicrobial source.

18. An apparatus according to claim 1, wherein the water inlet is at the upper side of the housing and the drain (8, 13) is at the lower end of the housing (1).

19. An apparatus according to claim 1, wherein the water inlet (2) is at the lower side of the housing and a drain (8) at the upper end of the housing (1).

20. An apparatus according to claim 1, wherein the permeate connector (5) is at the side of the housing.

21. An apparatus according to claim 1, further comprising a raw water reservoir connected to the contaminated water inlet (2) of the housing and located at least 50 cm above the housing for gravity feeding of the water to the housing.

22. An apparatus according to claim 1, wherein the housing is elongate with a longitudinal axis, and wherein the manually activated pump comprises a bellow with first shoulders (30) and second shoulders (31) for compression of the bellow (10′) when the first shoulders (30) are pressed towards the second shoulders (31) along a longitudinal axial direction of the housing (1).

23. An apparatus according to claim 1, wherein the wherein the housing (1) is elongate with a longitudinal axis, and wherein the manually activated pump comprises a set of handles (34, 34′) for compressing a bellow (10′), the handles being hinged for compression movement of the bellow in a direction substantially normal to the longitudinal axis of the housing 1.

24. An apparatus according to claim 1, wherein the manually activated pump comprises a single handle (34) for compressing a bellow (10′), the handle being hinged for compression movement of the bellow in a direction substantially normal to the longitudinal axis of the housing 1, wherein the handle also comprises a squeezer for closing a drain tube when the bellow is not compressed.

25. An apparatus according to claim 1, wherein the manually activated pump comprises a compressible balloon (10′) covering part of a surface of the housing.
